(19) United States
(12) Patent Application Publication
(10) Pub. No.: US 2023/0349776 A1
(43) Pub. Date: Nov. 2, 2023

(54) SENSOR BODY HAVING A MEASURING ELEMENT AND METHOD FOR MANUFACTURING FOR A SENSOR BODY

(71) Applicant: WIKA Alexander Wiegand SE & Co. KG, Kinggenberg (DE)

(72) Inventors: Andre ROTHER, Woerth am Main (DE); Alexander WILL, Laudenbach (DE); Achim STICH, Hornbach (DE); Juergen PLEYER, Stockstadt (DE)

(73) Assignee: WIKA Alexander Wiegand SE & Co. KG, Klingenberg (DE)

(21) Appl. No.: 18/218,793

(22) Filed: Jul. 6, 2023

Related U.S. Application Data
(63) Continuation of application No. 17/020,759, filed on Sep. 14, 2020.

(30) Foreign Application Priority Data
Sep. 12, 2019 (DE) 10 2019 124 510.9

(51) Int. Cl. G01L 1/16; G01L 5/171

(52) U.S. Cl. CPC G01L 1/16; G01L 5/171

(57) ABSTRACT

A sensor body for receiving a pressurized fluid or for absorbing a force, having a membrane and at least one strain sensitive measuring element disposed on the membrane, comprising, a semiconductor substrate and at least one piezo resistive resistance track, wherein the resistance track is formed in the semiconductor substrate by means of doping. According to the invention, the measuring element is connected to the membrane by means of a lead-free glass solder and the measuring element is arranged, at least in sections, sunk into the glass solder. A measuring element, a pressure sensor, a force measuring device, a method for manufacturing a sensor body and the use of a measuring element is also provided.

This nonprovisional application is a continuation of U.S. application Ser. No. 17/020,759 filed on Sep. 14, 2020, which claims priority under 35 U.S.C. § 119(a) to German Patent Application No. 10 2019 124 510.9, which was filed in Germany on Sep. 12, 2019, and which are both herein incorporated by reference.

### BACKGROUND OF THE INVENTION

### Field of Invention

The invention relates to a sensor body. The invention further relates to a measuring element for a sensor body and a use of such a measuring element. Further, the invention relates to a pressure sensor for converting a pressure into an electric signal and a method for manufacturing a sensor body. Furthermore, the invention relates to a force measuring device.

### Description of the Background Art

So-called pressure sensors and methods for their manufacture are generally known from the prior art. Pressure sensors are electric transducers for measuring pressure, in particular relative pressure, absolute pressure or differential pressure, and each include a sensor body with at least one measuring element arranged on a membrane. To measure the pressure, this is converted into a mechanical deflection of the membrane, wherein the conversion is detected and processed electrically. The measurement is carried out on the basis of a detection of a change in resistance by means of strain gauges and/or on the basis of the so-called piezo resistive effect, on the basis of a voltage change by means of the so-called piezoelectric effect, on the basis of a change in capacitance, on the basis of a change in inductance or on the basis of the so-called Hall effect. In such an application, a sensor body is also referred to as a pressure sensor body.

Furthermore, so-called force measuring devices and methods for their manufacture are generally known from the prior art. Force measuring devices are electrical measuring transducers for measuring forces, in particular . . . , and each comprise a sensor body with at least one measuring element arranged on a membrane. To measure the force, a force is introduced into the sensor body via a mechanical connection, which leads to a deflection or deformation of the membrane, wherein the deformation is detected and processed electrically. The measurement is carried out on the basis of a detection of a change in resistance by means of strain gauges and/or on the basis of the so-called piezoresistive effect, on the basis of a voltage change by means of the so-called piezoelectric effect, on the basis of a change in capacitance, on the basis of a change in inductance or on the basis of the so-called Hall effect. In such an application, a sensor body is also referred to as a force sensor body.

### SUMMARY OF THE INVENTION

It is therefore an object of the present invention to provide an improved sensor body as compared to the prior art, an improved measuring element for a sensor body, an improved pressure sensor, an improved force measuring device, an improved method for manufacturing a sensor body and a use of a measuring element.

In an exemplary embodiment, a sensor body is provided for receiving a pressurized fluid or for receiving forces introduced into the sensor body comprises a membrane and at least one strain sensitive measuring element disposed on the membrane. The measuring element comprises a semiconductor substrate and at least one piezoresistive resistance track, wherein said resistance track is formed by doping in the semiconductor substrate.

The measuring element can be connected to the membrane by means of a lead-free glass solder and the measuring element is arranged sunk into the glass solder, at least in sections. This means that the measuring element has at least partially sunk into the glass solder; at least one volume part of the measuring element has sunk into the glass solder.

The glass solder creates a reliable connection between the semiconductor substrate of the measuring element and the membrane and enables a compensation of different thermal expansions of the semiconductor substrate and the membrane. Due to the lead-free design of the glass solder, it is particularly environmentally friendly and is able to comply with legal requirements, such as the RoHS directive. The sunken arrangement of the measuring element causes a mechanically particularly stable connection between the membrane and the measuring element.

The semiconductor substrate has an upper side and a lower side, wherein a surface of the upper side in the plan view projects beyond a surface of the lower side over its entire edge, so that the lower side has a smaller surface area than the upper side. That is, the semiconductor substrate tapers from its upper side to its lower side. Depending on its composition, lead-free glass solder typically has other material properties than leaded glass solder, such as a different melting temperature, a different surface tension and a different viscosity of the melt at a given temperature. This affects the sinking of the measuring element into the glass solder. However, the downwardly tapered configuration of the measuring element also allows for reliable sinking of the measuring element (with its lower side first) into the solder glass even with lead-free glass solder, without any additional force on the measuring element being required or a critical increase in the temperature of the glass solder on values which are significantly higher than the usual temperatures when using lead-containing glass solder and/or which damage the measuring element or the membrane or lead to crystallization or pore formation on the glass solder itself. A “floating” of the measuring element on the glass solder is thus effectively avoided; a clean connection of the glass solder to the measuring element is achieved and/or the measuring element is connected, mechanically clamped to the glass solder on all sides.

The semiconductor substrate can have a thickness of 0.005 mm to 0.1 mm and/or a width of 0.1 mm to 2.8 mm and/or a length of 0.2 mm to 3.8 mm. For example, the upper side and lower side are at least substantially parallel to one another and have an at least substantially rectangular shape. Such dimensions and/or such a shape have proven to be particularly advantageous on the one hand for realizing a measuring function of the measuring element and on the other hand as particularly advantageous with regard to the sinking into the glass solder. In particular, an especially mechanically stable connection of the measuring element with the glass solder and thus with the membrane is achieved with such dimensions and/or such a shape. Furthermore, such dimensions and/or such a shape of this type make it possible to produce the semiconductor substrate in large numbers and at low costs.

Side faces of the semiconductor substrate are formed continuously tapered, at least in sections, from the upper side toward the lower side, in particular consistently continuously tapered from the upper side to the lower side. Such a shape of the side faces is particularly simple and inexpensive to manufacture by means of a sawing process. In this case, an average angle of a side face cross-section to a surface normal of the upper side is more than 0°, in particular at least 5°, in particular at least 15°. An embodiment of the tapering of the semiconductor element with average angles in this range allows for a particularly reliable sinking of the measuring element into the glass solder while simultaneously providing a mechanically stable connection of the measuring element with the glass solder and thus with the membrane.

The side faces have a flat surface so that the semiconductor substrate can be at least substantially the shape of a truncated pyramid, wherein the upper side forms a base of the truncated pyramid and the lower side forms an upper side surface of the truncated pyramid. Such a design of the semiconductor substrate has proven to be particularly suitable for sinking the measuring element into a lead-free glass solder.

The side faces of the semiconductor substrate have a concave surface, at least in sections. A tapering of the semiconductor substrate with such a concave formation of the surfaces of the side faces also enables the measuring element to sink in reliably while at the same time providing a mechanically stable connection of the measuring element to the glass solder and thus to the membrane. The concave formation can be manufactured economically by means of etching.

The side faces of the semiconductor substrate can have a wave-like undulating surface at least in sections. A tapering of the semiconductor substrate with such a wave-like configuration of the surfaces of the side faces also enables the measuring element to sink in reliably while at the same time providing a mechanically particularly stable connection of the measuring element to the glass solder and thus to the membrane. The wave-shaped configuration can be economically manufactured by machining the semiconductor substrate using a laser, wherein the processing is carried out in particular in several steps with in each case decreasing beam waists of the laser or is manufactured by etching.

A ratio between a length and an average width of the resistance track can equate to at least 2:1, especially at least 5:1, in particular at least 10:1, in particular at least 20:1. With such a ratio between the length and the average width of the resistance track, the latter can easily be integrated even in semiconductor substrates with particularly small dimensions while at the same time reliably detecting a change in the membrane shape. It is further achieved by such a ratio that the sensitivity of the measuring element to strain along a direction traverse to the course direction or longitudinal direction is increased in relation to the sensitivity of the measuring element to strain along a direction transverse to the running direction or the longitudinal direction, so that high measurement accuracy is achieved.

The resistance track can have a strip shape or a meandering shape. The resistance track in the strip shape is particularly simple and inexpensive to manufacture. The resistance track with a meandering shape makes it possible to achieve a long extension of the resistance track in the direction of the strain load even on a semiconductor substrate with limited dimensions, while at the same time the extension of the resistance track in the transverse direction is small. As a result, the achievable measurement signal can be increased, and the measurement accuracy can consequently be improved. However, the resistance track can also have any other shape.

The semiconductor substrate can include at least two resistance tracks, wherein the resistance tracks are arranged in particular adjacent to each other. Such a design brings, inter alia, a significant cost advantage, since fewer individual elements have to be cut or sawed from a wafer when manufacturing the measuring elements, and fewer individual elements have to be positioned on the membrane when the measuring elements are used. The double design of the resistance track is particularly advantageous because a Wheatstone measuring bridge or Wheatstone bridge circuit can be generated on the membrane in a particularly simple manner. Here, two resistance tracks can be used in a common first measuring element in an edge region of the membrane in which a negative strain (compression) of a surface of the membrane is present. Another two resistance tracks can be used in a central area of the membrane in a common second measuring element at which a positive strain (stretching) of the surface is present. The resistance tracks are to be connected to form a measuring bridge in such a way that in each case the two resistance tracks, which are arranged in an area with the same strain direction, lie diagonally opposite each other in the circuit diagram of the measuring bridge. On the other hand, an embodiment with four separate resistance tracks on one measuring element is disadvantageous for achieving such an arrangement, since this measuring element would then have to have a very large area due to the necessary arrangement of the resistance tracks in different areas of the membrane. This would result in very high costs.

Each resistance track can comprise contact surfaces at their ends, wherein contact surfaces of different resistance tracks are mutually electrically insulated. The contact surfaces enable the resistance tracks to be contacted independently of one another, wherein the electrical insulation makes it possible to separately detect changes in the shape of the membrane by means of the resistance tracks as well as to separate evaluate signals generated by means of the resistance tracks.

The semiconductor substrate can comprise a silicon crystal. Here, the at least one resistance track is formed by a patterned p-type doping in the semiconductor substrate and lies at least substantially in a {110} crystal plane of the silicon crystal and extends at least substantially along a <110> crystal direction or a <111> crystal direction. Alternatively, the at least one resistance track is formed by a structured n-type doping in the semiconductor substrate and lies at least essentially in a {100} crystal plane or a {110} crystal plane of the silicon crystal and runs at least essentially along a <100> crystal direction. Such a doping and arrangement of the at least one resistance track makes it possible in a particularly advantageous manner for a measuring direction of the resistance track to run along a crystal direction, in which the resulting piezoresistive coefficient of the silicon material comprising a longitudinal component along the crystal direction as well as transverse components, is optimized and thus, increased measuring sensitivity of the measuring element is achieved. For example, a ratio of the longitudinal to the transverse piezoresistive coefficient can be optimized in the selected direction or all coefficients can have the same sign. Thus, sensitivity of the measuring element to strain transverse to the measuring direction is minimized. It follows that a transverse strain, so for example introducing mechanical stresses along the transverse direction of the resistance track, decreases, or even increases, the output signal by orders of magnitude that are substantially less than in the conventional semiconductor strain gauge sensors. Thus, when forming a Wheatstone bridge circuit, resistance tracks in the edge area can be dispensed with. In fact, inexpensive fixed resistors can be used because the measuring sensitivity in the longitudinal direction is already very high. Stress analyses are also possible, since the strain gauge sensor only reliably measures the strain when the measuring direction is loaded. Here, the sensitivity of said sensor is much greater than transverse to this measuring direction. Thus, for example, when the resistance track extends in the longitudinal direction of the same, electrical resistance of the resistance track increases, but a compression of the resistance track in the transverse direction resulting from the stretching (=so-called transversal effect) does not reduce the electrical resistance thereof. That means, because of this doping and arrangement of the at least one resistance track, the electrical resistance of the latter remains constant when changing its width. Thus, a particularly large signal change can be detected, which enables a simple and reliable determination of the membrane deformations. The at least one resistance track can also be generated with a particularly small ratio between its length and its width, so that it can be implemented in a simple manner even with particularly compact semiconductor substrates.

The sensor body can have a hat shape, in particular a top hat shape. Such a hat shape is characterized in particular by the fact that it comprises a cover surface which is formed by the membrane. In an unloaded state of the sensor body, a lateral surface extending at least substantially perpendicular to the cover surface terminates in a peripheral flange-like structure, which in the unloaded state of the sensor body at least protrudes substantially perpendicularly from the lateral surface, on an end facing away from the cover surface of the lateral surface. The flange-like structure is formed in particular to attach the sensor body within a pressure sensor, or within or on a force measuring device. In an arrangement in a pressure sensor, the hat shape allows for reliable detection of pressure changes that are simple to carry out as well as easy integration of the sensor body in a pressure sensor. When arranged in or on a force measuring device, the hat shape allows for a force to be introduced particularly effectively from a deformation body via the flange-like structure into the sensor body. This makes it particularly easy to detect forces or stresses and the sensor body can be integrated particularly easily into a force measuring device.

The sensor body can have a diameter of 2.5 mm to 15 mm. Such diameters allow for an economical manufacture and processing of sensor bodies and a simple application of the measuring elements, wherein at the same time, a broad range of pressure measuring ranges with sufficient overpressure protection and high accuracy can be covered. This way, sensor bodies with such diameter sizes, having a very high measuring accuracy despite the small diameter sizes, can be realized due to the formation of the measuring elements and the possibility of realizing these in particularly small dimensions with at the same time particularly large signal changes in a deformation. Furthermore, due to the increased measuring accuracy and sensitivity, sensor bodies can be manufactured with a higher overpressure protection.

The sensor body can be made of an iron alloy, in particular of a stainless steel. Alternatively, the sensor body is made from a non-ferrous metal alloy, wherein the non-ferrous metal alloy is in particular coated with a metallic adhesion-promoting layer, or the sensor body is made of a ceramic. Due to the possibility of manufacturing the sensor body from these materials, it can be easily adapted to different applications. In particular, thus a high resistance to different media in the different applications can be realized.

At least four resistance tracks can be arranged on the membrane and interconnected such that they form a Wheatstone bridge circuit. Here, the resistance tracks, for example, are evenly distributed over a maximum of four separate measuring elements, and in particular distributed over a maximum of two separate measuring elements, formed in particular in the semiconductor substrate of a single measuring element. By means of the Wheatstone bridge circuit, a change in the shape of the membrane may be determined in a particularly precise and reliable manner, so that particularly accurate and reliable pressure measurement is made possible. When using two measuring elements, each with two resistance tracks, the Wheatstone bridge circuit can be generated on the membrane in a particularly simple manner, wherein—as already described—two resistance tracks can be used in a common first measuring element in an edge region of the membrane in which compression of the membrane surface is present, and two further resistance tracks can be used in a common second measuring element in a central region of the membrane in which the surface is stretched. The resistance tracks are to be connected to form a measuring bridge in such a way that in each case the two resistance tracks, which are arranged in a common measuring element, lie diagonally opposite each other in the circuit diagram of the measuring bridge.

Four resistance tracks can be formed in the semiconductor substrate of a single measuring element, wherein the resistance tracks are formed by a structured p-type doping in the semiconductor substrate and at least substantially lie in a {110} crystal plane of the silicon crystal. In this case, two of the four resistance tracks form a first pair, which is oriented at least substantially along a <110> crystal direction or a <111> crystal direction or extends in one of these crystal directions. The remaining two resistance tracks form a second pair, which is aligned essentially perpendicular to the alignment of the first pair of resistance tracks. Thus, the first pair of resistance tracks runs in a direction in which the resistance, as already described in a previous section, substantially depends only on strain in the direction of the tracks, while the second pair of resistance tracks runs in a transverse direction thereto, in which the resistance is essentially independent of strain in this transverse direction. The four resistance tracks may in particular be interconnected to a Wheatstone bridge circuit in such a way that the resistance tracks of the first pair as well as the resistance tracks of the second pair are in each case diagonally opposed in the circuit diagram of the bridge circuit. This has the advantage that a measuring element with such a measuring bridge is essentially only sensitive to strain, that is to say stretching/compression, along the orientation of the first pair of resistance tracks, and a very precise measuring signal can be tapped in relation thereto. The connection to a measuring bridge can be formed within the semiconductor substrate or can also be manufactured outside the measuring element by contacting the individual resistance tracks. A sensor body can especially be manufactured easily and inexpensively with such a measuring element, since only one measuring element is required. In addition, this can be arranged anywhere on the membrane. The sensor body can be manufactured particularly advantageously by arranging such a measuring element centrally on the membrane, since this way essentially no asymmetries in the loading of the membrane are created.

The at least one measuring element can be arranged in the glass solder such that a glass solder film having a thickness of 0.001 mm to 0.1 mm is formed between the lower side of the measuring element and the surface of the membrane. This results in a particularly accurate transmission of the strain of the membrane, i.e., a change in the shape thereof, on the measuring element so that a particularly accurate measurement possible. Alternatively, or additionally, the upper side of the measuring element protrudes from the glass solder by 0 percent to 95 percent of the thickness of the measuring element. In particular, the upper side of the measuring element is arranged at least substantially flush with a surface of the glass solder in the latter and is thus at least largely protected against outside influences.

A measuring element for arrangement on a sensor body comprises a semiconductor substrate and at least one piezoresistive resistance track, wherein said resistance track is formed in the semiconductor substrate by doping.

According to the invention, the semiconductor substrate has an upper side and a lower side, wherein a surface of the upper side fully projects beyond a surface of the lower side in the plan view, so that the lower side has a smaller surface area than the upper side. That is, the semiconductor substrate tapers from its upper side to its lower side.

Depending on its composition, lead-free glass solder typically has other material properties than leaded glass solder, such as a different melting temperature, a different surface tension and a different viscosity of the melt at a given temperature. This affects the sinking of the measuring element into the glass solder. However, the downwardly tapered configuration of the measuring element also allows for reliable sinking of the measuring element (with its lower side first) into the glass solder even if it is lead-free, without any additional force action on the measuring element or a critical increase in temperature of the glass solder being required on values which are significantly higher than usual temperatures when using leaded glass solder and/or which damage the measuring element or the membrane or lead to crystallization or pore formation on the glass solder itself. A “floating” of the measuring element on the glass solder is thus effectively prevented, so that a mechanically stable connection of the measuring element with a lead-free glass solder and thus with a membrane of a sensor body can be realized in a simple manner and/or the measuring element is connected, mechanically clamped, on all sides with the glass solder.

In a possible configuration of the measuring element, the semiconductor substrate can have a thickness of 0.005 mm to 0.1 mm and/or a width of 0.1 mm to 2.8 mm and/or a length of 0.2 mm to 3.8 mm. For example, the upper side and the lower side are at least substantially parallel to one another and have, for example, an at least substantially rectangular shape. Such dimensions and/or such a shape have proven to be particularly advantageous on the one hand for realizing a measuring function of the measuring element and on the other hand as particularly advantageous with regard to sinking into the glass solder. In particular, with such dimensions and/or such a shape, a mechanically particularly stable connection of the measuring element with a lead-free glass solder and thus with the membrane of the sensor body is achieved. Furthermore, such dimensions and/or a shape of this type enable the semiconductor substrate to be manufactured in large numbers and at low costs.

In a further possible configuration of the measuring element, side faces of the semiconductor substrate are designed to taper continuously, at least in sections, from the upper side toward the lower side, in particular taper consistently and continuously from the upper side to the lower side. Such a shape of the side surfaces is particularly simple and inexpensive to manufacture by means of a sawing process. In this case, an average angle of a side face cross-section to a surface normal of the upper side is more than 0°, in particular at least 5°, in particular at least 15°. Forming the taper of the semiconductor element with average angles in this area enables the measuring element to sink particularly reliably into the glass solder while at the same time providing a mechanically stable connection of the measuring element to the glass solder and thus to the membrane.

In a further possible configuration of the measuring element, the side faces can have a flat surface so that the semiconductor substrate is at least substantially the shape of a truncated pyramid, wherein the upper side forms a base of the truncated pyramid and the lower side forms a cover surface of the truncated pyramid. Such a design of the semiconductor substrate has proven to be particularly suitable for sinking the measuring element into a lead-free glass solder.

In a further possible configuration of the measuring element, the side faces of the semiconductor substrate can have a concave surface, at least in sections. A tapering of the semiconductor substrate with a concave design of the surfaces of the side faces also enables the measuring element to sink in reliably while at the same time providing a mechanically stable connection of the measuring element to the glass solder and thus to the membrane. The concave formation can be manufactured economically by means of etching.

In a further possible configuration of the measuring element, the side faces of the semiconductor substrate can have a wavy surface, at least in sections. A tapering of the semiconductor substrate with such a wave-like configuration of the surfaces of the side faces also enables the measuring element to sink in reliably while at the same time providing a mechanically particularly stable connection of the measuring element to the glass solder and thus to the membrane. The wave-shaped configuration is manufactured in an economic manner by machining the semiconductor substrate using a laser, wherein processing in particular in several steps is carried out with an in each case decreasing beam waist of the laser or is generated by etching.

In a further possible configuration of the measuring element, a ratio between a length and an average width of the resistance track corresponds to at least 2:1, in particular at least 5:1, in particular at least 10:1, in particular at least 20:1. With such a ratio between the length and the average width of the resistance track, the latter can easily be integrated even in semiconductor substrates with particularly small dimensions while at the same time reliably detecting a change in the shape of the membrane. It is further achieved by such a ratio that the sensitivity of the measuring element to strain along the running direction or the longitudinal direction is increased in relation to the sensitivity of the measuring element to strain along a transverse direction to the running direction or the longitudinal direction, so that high measurement accuracy is achieved.

In a further possible configuration of the measuring element, the resistance track can have a strip shape or a meandering shape. The resistance track in the strip shape is particularly simple and inexpensive to manufacture. The resistance track in the meandering shape enables a long extension of the resistance track in the direction of the strain exposure to be achieved even on a semiconductor substrate with limited dimensions, while at the same time the extension of the resistance track in the transverse direction is small. As a result, the achievable measurement signal can be enhanced, and the measurement accuracy can consequently be increased. However, the resistance track can also have any other shape.

In a further possible configuration of the measuring element, the semiconductor substrate comprises at least two resistance tracks, wherein the resistance tracks are in particular arranged next to one another. Such a design provides, among other things, a significant cost advantage, since fewer individual elements have to be cut or sawed from a wafer during the manufacture of the measuring elements, the area of the wafer can be used more effectively, and fewer individual elements have to be positioned when the measuring elements are applied to the membrane. The double design of the resistance track is particularly advantageous because a Wheatstone measuring bridge or Wheatstone bridge circuit can be produced on the membrane in a particularly simple manner. In this case, two resistance tracks can be used in a common first measuring element in an edge region of the membrane in which a surface of the membrane is compressed. Two further resistance tracks can be used in a common second measuring element in a central area of the membrane where the surface is stretched. The resistance tracks are to be connected to form a measuring bridge in such a way that in each case the two resistance tracks, which are arranged in an area with the same strain direction, lie diagonally opposite each other in the circuit diagram of the measuring bridge. A design with four separate resistance tracks on a measuring element, however, is disadvantageous when it comes to achieving such an arrangement, as this measuring element would then need to be formed with a very large area due to the necessary arrangement of the resistance tracks in different regions of the membrane. This would result in very high costs.

In a further possible configuration of the measuring element, each resistance track comprises contact areas at its ends, wherein the contact areas of different resistance tracks are electrically insulated from one another. The contact areas enable the resistance tracks to be contacted independently of one another, wherein the electrical insulation makes it possible to separately detect changes in the membrane's shape by means of the resistance tracks and by separately evaluating signals generated by the resistance tracks.

In a further possible configuration of the measuring element, the semiconductor substrate comprises a silicon crystal. Here, the at least one resistance track is formed by a structured p-type doping in the semiconductor substrate and the resistance track lies at least substantially in a {110} crystal plane of the silicon crystal and extends at least substantially along a <110> crystal direction or a <111> crystal direction. Alternatively, the at least one resistance track is formed by a structured n-type doping in the semiconductor substrate and lies at least essentially in a {100} crystal plane or a {110} crystal plane of the silicon crystal and runs at least essentially along a <100> crystal direction. Such a doping and arrangement of the at least one resistance track makes it possible in a particularly advantageous manner for a measuring direction of the resistance track to run along a crystal direction in which the resulting piezoresistive coefficient of the silicon material, comprising a longitudinal component along the crystal direction as well as transverse components, is optimized and thus, an increased measuring sensitivity of the measuring element is achieved. For example, a ratio of longitudinal to transverse piezoresistive coefficients can be optimized in the selected direction, or all coefficients can have the same sign. This minimizes the sensitivity of the measuring element to strain across the measuring direction. As a result, lateral strain, i.e., for example an introduction of mechanical stresses along the transverse direction of the resistive track, reduces, or even increases, the output signal greatly less in orders of magnitude than in conventional semiconductor strain gauge sensors. Thus, when forming a Wheatstone bridge circuit, resistance tracks in the edge area can be dispensed with. In fact, inexpensive fixed resistors can be used because the measuring sensitivity in the longitudinal direction is already very high. Stress analyses are also possible, since the strain gauge sensor only reliably measures the strain when the measuring direction is loaded. Here, the sensitivity of the same is much greater than transverse to this measuring direction. Thus, for example, when the resistance track extends in the longitudinal direction of the same, electrical resistance of the resistance track increases, but compression of the resistance track in the transverse direction resulting from the stretching (=so-called transversal effect) does not reduce the electrical resistance thereof. This means that due to this doping and arrangement of the at least one resistance track, its electrical resistance remains constant when its width changes. A particularly large signal change can thus be detected, which enables simple and reliable determination of the changes of the membrane's shape. The at least one resistance track can also be generated with a particularly small ratio between its length and its width, so that it can be realized in a simple manner even with particularly compact semiconductor substrates.

Four resistance tracks can be formed in the semiconductor substrate of the measuring element, wherein the resistance tracks are formed by a structured p-type doping in the semiconductor substrate and at least essentially lie in a {110} crystal plane of the silicon crystal. In this case, two of the four resistance tracks form a first pair, which is oriented at least substantially along a <110> crystal direction or a <111> crystal direction or extends in one of these crystal directions. The remaining two resistance tracks form a second pair, which is aligned essentially perpendicular to the alignment of the first pair of resistance tracks. Thus, the first pair of resistance tracks runs in a direction in which the resistance, as already described in a previous section, depends essentially only on strain in the direction of the tracks, while the second pair of resistance tracks runs in a transverse direction thereto, in which the resistance is essentially independent of strain in this transverse direction. The four resistance tracks can in particular be interconnected to form a Wheatstone bridge circuit in such a way that the resistance tracks of the first pair and the resistance tracks of the second pair are diagonally opposite in the circuit diagram of the bridge circuit. This has the advantage that a measuring element with a such a measuring bridge is sensitive essentially only to strain, i.e., stretching/compression, along the alignment of the first pair of resistance tracks and that a very accurate measurement signal with respect thereto can be tapped. The connection to a measuring bridge can be formed within the semiconductor substrate or can also be produced outside the measuring element by contacting the individual resistance tracks. With such a measuring element, a sensor body can be manufactured particularly simply and inexpensively, since only one measuring element has to be applied. In addition, this can be arranged anywhere on a membrane. A sensor body can be manufactured particularly advantageously by arranging such a measuring element centrally on a membrane of the sensor body, since this essentially provides that no asymmetries are created in the loading of the membrane.

The inventive pressure sensor for converting a pressure into an electric signal comprises as components a previously described sensor body, a terminal body, a housing, an evaluation electronics and a transmission. The components are arranged such that the terminal body sealingly connects to the sensor body, the terminal body can be sealingly connected to a fluid source, and a fluid can be introduced in the sensor body by means of the terminal body, the evaluation electronics is electrically connected to the at least one resistance track and is set up to convert a change in resistance of the resistance track to an electrical measurement signal. Furthermore, the housing is connected to the sensor body and/or the terminal body, so that at least the membrane, the measuring element and the evaluation electronics are enclosed by the housing, at least in sections. This means that the membrane, the measuring element and the evaluation electronics are at least partially enclosed by the housing or are at least partially located inside a housing chamber. Furthermore, the transmission is connected to the evaluation electronics in such a way that it converts the electrical measurement signal to an electrical output signal and either makes it available by means of contacts accessible from outside the housing or emits it as a radio signal.

By using the pressure sensor with lead-free glass solder, the sensor body is characterized on the one hand by a particularly high environmental compatibility, and can also be in compliance with legal requirements, such as the RoHS directive. On the other hand, the pressure sensor is characterized by the above-mentioned advantages of the sensor body resulting from the respective configurations of the sensor body.

The force measuring device according to the invention for converting a force to an electrical signal includes as components at least one above-described sensor body, a bearing area portion, a load introduction area, an evaluation electronics, a transmission and a deformation section, in which the sensor body is arranged. The components are arranged such that the deformation section is connected to the sensor body and a force is introduced in the sensor body by means of the deformation section. The evaluation electronics is electrically connected to the at least one resistance track and arranged to convert a change in resistance of the resistance track to an electrical measurement signal. The transmission is connected to the evaluation electronics in such a way that it converts the electrical measurement signal to an electrical output signal and either makes it available by means of contacts or emits it as a radio signal.

By using the sensor body with lead-free glass solder, the force measuring device is characterized on the one hand by a particularly high environmental compatibility, and can also conform to legal requirements, such as the RoHS directive. On the other hand, the force measuring device is distinguished by the advantages of the sensor body already mentioned, resulting from the respective configurations of the sensor body.

In the inventive method for manufacturing a previously described sensor body, in a step A, a sensor body, at least one measuring element and a lead-free glass solder paste are provided, wherein the glass solder paste comprises glass particles and volatile, in particular organic, components. In a step B, the glass solder paste is applied to at least one surface portion of the membrane of the sensor body. In a step C, the measuring element is applied on or in the glass solder paste, before in a step D, the sensor body is heated to at least a temperature and the sensor body is stored at least at this temperature for a storage period, such that the volatile components of the glass solder paste vaporize, the glass particles contained in the glass solder paste re-melt to a glass solder and the measuring element sinks into the glass solder thus formed. In a step E, the sensor body is cooled so that the glass solder solidifies.

By means of the method, a sensor body can be manufactured with lead-free glass solder in a simple and reliable manner. The lead-free glass solder paste is available at particularly low cost and offers much higher mechanical stability and greater resistance to environmental influences than suitable adhesives. Further, the glass solder paste and, consequently, the sensor body, are particularly easy to handle. This results from the fact that the applied glass solder paste remains in place, so that it is easy to transport the sensor body with the applied glass solder paste. Furthermore, the glass solder paste can be applied in any amount, so that it can be used for a variety of different sensor bodies.

The temperature to which the sensor body is heated can be between 300 degrees Celsius and 600 degrees Celsius. The sensor body is stored at this temperature, for example, for a storage period between 30 seconds and 5 hours. Suitable temperatures and storage times depend on the selected glass solder make and its specifications. In particular, the heating and storage of the sensor body can take place over at least two stages, wherein the volatile components of the glass solder paste are vaporized at a first lower temperature stage and then, at a second higher temperature stage, the glass particles are re-melted into a glass solder.

In an example of the method, at least a step B.1 is performed between step B and step C, in which the sensor body is heated to at least a temperature and the sensor body is stored at this temperature for a storage period in such a way that the volatile components of the glass solder paste vaporize and the glass particles melt. This process can in particular be carried out in two stages, as described in the previous section. If the volatile components of the glass solder paste are vaporized, the glass particles are re-melted to a glass solder before the measuring element is applied, the volatile components of the glass solder paste can vaporize unimpeded and a bubble-free glass layer is formed. Thus, the formation of bubbles and the formation of inclusions can be at least largely avoided, so that mechanical stability and later measurement accuracy are not impaired.

In an example of the method, a further step B.2 is performed between step B.1 and step C, in which the sensor body is cooled such that the glass solder solidifies.

In the method for manufacturing an above-described sensor body, a sensor body, at least one measuring element and at least one lead-free molded glass part can be provided in a step A. In a step B, the molded glass part is placed on a surface portion of the membrane of the sensor body. In a step C, the measuring element is applied on the molded glass part, before, in a step D, the sensor body is heated to a temperature and the sensor body is stored at this temperature for a storage period such that the molded glass part melts and the measuring element sinks into a glass solder thus created. Subsequently, in a step E, the sensor body is cooled so that the glass solder formed from the molded glass part solidifies.

Also, in this embodiment of the method, a sensor body with lead-free glass solder can be manufactured in a simple and reliable manner. The molded glass part is particularly easy to handle and available at low cost. Furthermore, the glass solder can be easily applied in a defined amount by means of the molded glass part, and molded glass parts generally contain no volatile components, so that process steps for their volatilization can be omitted.

The temperature to which the sensor body is heated can be between 300 degrees Celsius and 600 degrees Celsius. The sensor body is stored at this temperature, for example, for a storage period between 30 seconds and 5 hours. Suitable temperatures and storage times depend on the make of the chosen molded glass part and its specifications.

In a further possible embodiment of the method, a further step B.1 is performed between step B and step C in which the sensor body is heated to a temperature and the sensor body is stored at this temperature for a storage period such that the molded glass part melts to a glass solder and adheres to the membrane, even before the measuring element is applied in the next step. This allows for easy connection of the sensor body with the applied glass solder since separate fixing of the molded glass part can be omitted.

In a further possible embodiment of the method, a further step B.2 is carried out between step B.1 and step C, in which the sensor body is cooled such that the glass solder resulting from the molded glass part solidifies before the measuring element is applied in the next step.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a sectional view of a sensor body,

FIG. 2 schematically shows a perspective view of the sensor body according to FIG. 1,

FIG. 3 schematically shows a perspective view of a measuring element with a view of an upper side of a semiconductor substrate of the measuring element,

FIG. 4 schematically shows a perspective view of the measuring element according to FIG. 3 with a view of a lower side of the semiconductor substrate of the measuring element,

FIG. 5 schematically shows a semitransparent plan view of a rectangular measuring element with a view of an upper side of a semiconductor substrate of the measuring element,

FIG. 6 schematically shows a semitransparent plan view of a hexagonal measuring element with a view of an upper side of a semiconductor substrate of the measuring element,

FIG. 7 schematically shows a plan view of the rectangular measuring element according to FIG. 4 with a view of a lower side of the semiconductor substrate of the measuring element,

FIG. 8 schematically shows a plan view of the hexagonal measuring element according to FIG. 6 with a view of a lower side of the semiconductor substrate of the measuring element,

FIG. 9 schematically shows a sectional view of a section of a sensor body,

FIG. 10 schematically shows a sectional view of a semiconductor substrate of a measuring element in an edge region,

FIG. 11 schematically shows a sectional view of a semiconductor substrate of a measuring element in an edge region,

FIG. 12 schematically shows a sectional view of a semiconductor substrate of a measuring element in an edge region,

FIG. 13 schematically shows a sectional view of a semiconductor substrate of a measuring element in an edge region,

FIG. 14 schematically shows a plan view of a section of a measuring element with a view of an upper side of a semiconductor substrate of the measuring element,

FIG. 15 schematically shows a plan view of a section of a measuring element with a view of an upper side of a semiconductor substrate of the measuring element,

FIG. 16 schematically shows a plan view of a section of a measuring element with a view of an upper side of a semiconductor substrate of the measuring element,

FIG. 17 schematically shows a sectional view of a section of a pressure sensor,

FIG. 18 schematically shows cross-sectional views of a section of a sensor body during various steps of a method for the manufacture thereof,

FIG. 19 schematically shows cross-sectional views of a section of a sensor body during various steps of a method for the manufacture thereof,

FIG. 20 schematically shows cross-sectional views of a section of a sensor body during various steps of a method for the manufacture thereof,

FIG. 21 schematically shows cross-sectional views of a section of a sensor body during various steps of a method for the manufacture thereof,

FIG. 22 schematically shows a sectional view of a sensor body in an unloaded state,

FIG. 23 schematically shows sectional views of the sensor body according to FIG. 22 in a loaded state,

FIG. 24 schematically shows an exemplary embodiment of a force measuring device and

FIG. 25 schematically shows another exemplary embodiment of a force measuring device.

### DETAILED DESCRIPTION

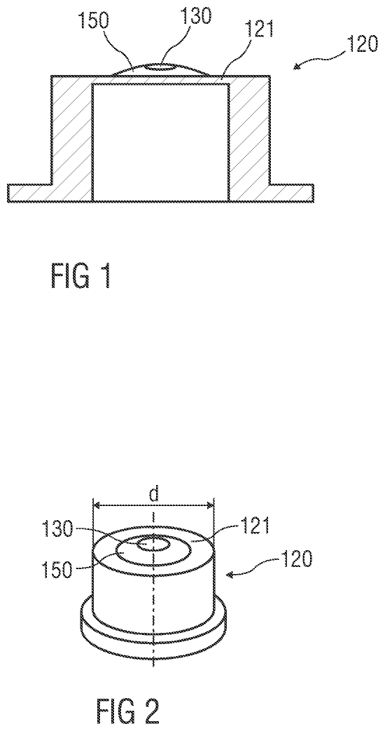

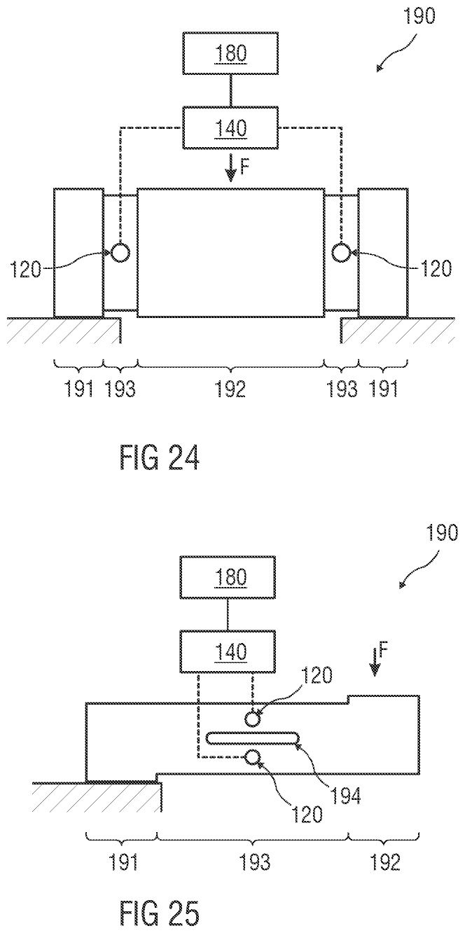

FIG. 1 shows a sectional view of a possible embodiment of a sensor body 120 for a pressure sensor 100 shown in FIG. 17 or for force measuring devices 190 shown in FIGS. 24 and 25. FIG. 2 shows a perspective view of the sensor body 120 according to FIG. 1.

The sensor body 120 is designed to receive a pressurized fluid or to absorb forces.

In the illustrated embodiment, the sensor body 120 has a hat shape in which the sensor body 120 comprises an upper side surface, which is formed by a membrane 121. In this case, the membrane 121 extends in particular over the entire width, in the exemplary embodiment shown over an entire diameter d, of the upper side surface. The diameter d is, for example, 2.5 mm to 15 mm.

For example, the sensor body 120 is made of an iron alloy, in particular of a stainless steel. Alternatively, the sensor body 120 is formed from a non-ferrous metal alloy, wherein the non-ferrous metal alloy is in particular coated with a metallic adhesion-promoting layer, or the sensor body 120 is formed of a ceramic.

A lateral surface, extending at least substantially perpendicular to the cover surface in an illustrated unloaded state of the sensor body 120, terminates in a peripheral flange-like structure which in the unloaded state of the sensor body 120 projects at least substantially perpendicularly at an end of the lateral surface facing away from the cover surface. The flange-like structure is thereby formed to mount the sensor body 120 within the pressure sensor 100, or to the force measuring device 190.

The sensor body 120 comprises at least one strain sensitive measuring element 130 disposed on an upper side of the membrane 121. The measuring element 130 is connected to the membrane 121 by means of a lead-free glass solder 150 and the measuring element 130 is arranged, at least in sections, sunk into the glass solder 150. That is, the measuring element 130 is at least partially sunk into the glass solder 150; at least one volume section of the measuring element 130 is sunk into the glass solder 150.

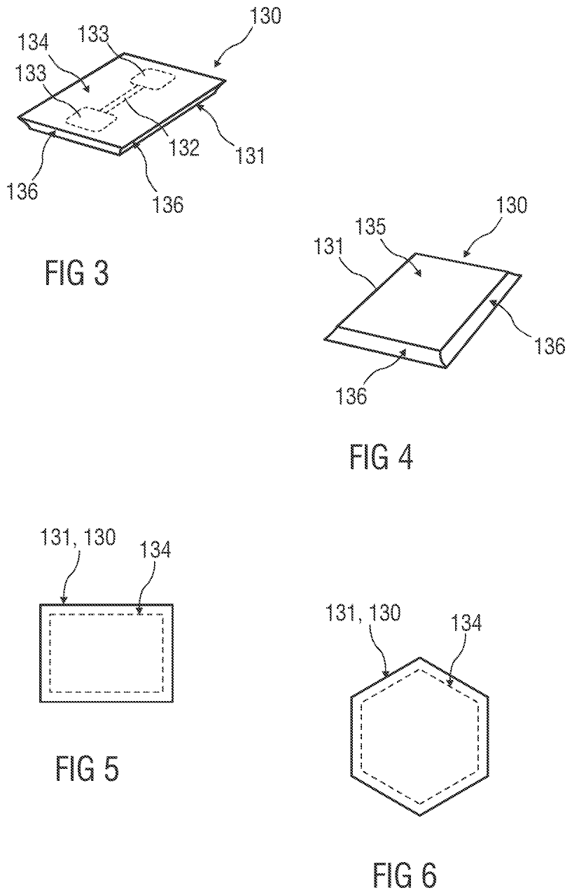

FIGS. 3 and 4 show perspective views of a possible exemplary embodiment of a measuring element 130 with a view of an upper side 134 and a lower side 135 of a semiconductor substrate 131 of the measuring element 130.

In addition to the semiconductor substrate 131, which is in particular a silicon crystal, the measuring element 130 comprises at least one piezoresistive resistance track 132, which is formed in the semiconductor substrate 131 by means of doping. The resistance track 132 has contact surfaces 133 at its ends to provide electrical contact.

The at least one resistance track 132 is in particular formed by a structured p-type doping in the semiconductor substrate 131 and lies at least essentially in a {110} crystal plane of the silicon crystal and runs at least essentially along a <110> crystal direction or a <111> crystal direction. Alternatively, the at least one resistance track 132 is formed by a structured n-type doping in the semiconductor substrate 131 and lies at least essentially in a {100} crystal plane or a {110} crystal plane of the silicon crystal and runs at least essentially along a <100> crystal direction.

The semiconductor substrate 131 has, for example, a thickness of 0.005 mm to 0.1 mm and/or a width of 0.1 mm to 2.8 mm and/or a length of 0.2 mm to 3.8 mm. For example, the upper side 134 and the lower side 135 are at least substantially parallel to one another and are at least substantially rectangular in shape.

In order to enable or simplify sinking of the measuring element 130 into the lead-free glass solder 150, side faces 136 of the semiconductor substrate 131 are continuously tapered, at least in sections, from the upper side 134 towards the lower side 135. This means that in a plan view, a surface of the upper side 134 extends over the edge of the entire circumference of a surface of the lower side 135, so that the lower side 135 is a smaller area than the upper side 134. The semiconductor substrate 130 thus tapers from its upper side 134 to its lower side 135.

FIG. 5 shows a semitransparent plan view of a possible embodiment of a rectangular measuring element 130 with a view of the upper side 134 of the semiconductor substrate 131 of the measuring element 130, which illustrates that in the plan view, the surface of the upper side 134 fully projects beyond the surface of the lower side 135 over its entire edge, so that the lower side 135 is a smaller area than the upper side 134 and the semiconductor substrate 131 tapers from its upper side 134 toward its lower side 135.

FIG. 6 shows a semitransparent plan view of a possible embodiment of a hexagonal measuring element 130 with a view of the upper side of the semiconductor substrate 131 of the measuring element 130, which demonstrates that in the plan view, the surface of the upper side 134 fully projects beyond the surface of the lower side 135 over its entire edge, so that the lower side 135 is a smaller area than the upper side 134 and the semiconductor substrate 131 tapers from its upper side 134 toward its lower side 135.

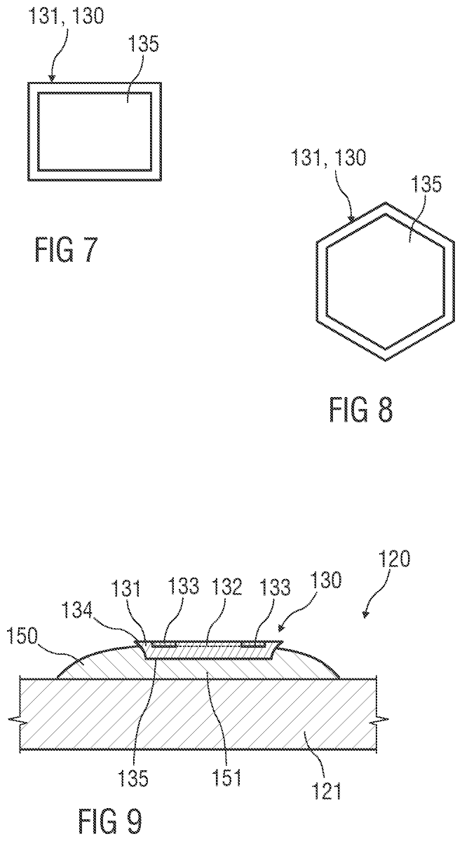

FIG. 7 shows a plan view of the rectangular measuring element 130 according to FIG. 5 with a view of the lower side 135 of the semiconductor substrate 131 of the measuring element 130.

FIG. 8 schematically shows a plan view of the hexagonal measuring element 130 according to FIG. 6 with a view of the lower side 135 of the semiconductor substrate 131 of the measuring element 130.

FIG. 9 shows a sectional view of a detail of a possible embodiment of a sensor body 120. In this embodiment, the measuring element 130, for example, is arranged such in the glass solder 150 that a glass solder film 151 having a thickness of 0.001 mm to 0.1 mm is formed between the lower side 135 of the measuring element 130 and a surface of the membrane 121, and/or the upper side 134 of the measuring element 130 protrudes from the glass solder 150 by 0 percent to 95 percent of the thickness of the measuring element 130. It is also possible for the measuring element 130 to be arranged at least substantially flush with a surface of the glass solder 150 in the latter.

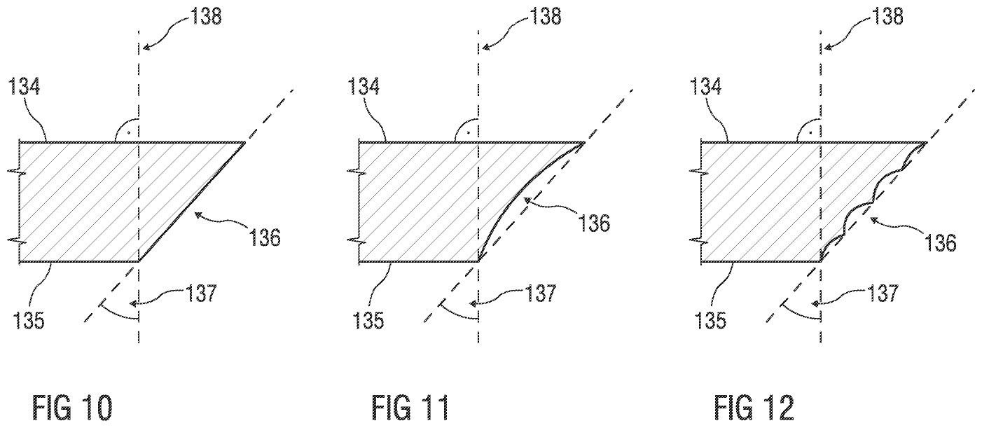

FIG. 10 shows a sectional view of a possible embodiment of a semiconductor substrate 131 of a measuring element 130 in an edge region.

In this exemplary embodiment, side faces 136 of the semiconductor substrate 131 are continuously tapered from the upper side 134 to the lower side 135 of the semiconductor substrate 131.

In this case, an average angle 137 of a side face cross section to a surface normal 138 of the upper side 134 is more than 0°, in particular at least 5°, in particular at least 15°.

The side faces 136 in particular have a flat surface, so that the semiconductor substrate 131 has at least substantially the shape of a truncated pyramid, wherein the upper side 134 forms a base of the truncated pyramid and the lower side 135 forms a cover surface of the truncated pyramid.

Such a shape of the side faces 136 is manufactured, for example, in a sawing process or in a laser cutting process.

FIG. 11 shows a sectional view of another possible embodiment of a semiconductor substrate 131 of a measuring element 130 in an edge region.

In this exemplary embodiment, the side faces 136 of the semiconductor substrate 131 have a concave surface, at least in sections.

Such a shape of the side surfaces 136 is manufactured, for example, in an etching process or in a laser cutting process.

In this case, an average angle 137 of an average side face cross section to a surface normal 138 of the upper side 134 is more than 0°, in particular at least 5°, in particular at least 15°.

FIG. 12 shows a sectional view of a further possible exemplary embodiment of a semiconductor substrate 131 of a measuring element 130 in an edge region.

In this exemplary embodiment, the side faces 136 of the semiconductor substrate 131 have a wavy surface, at least in sections.

Such a shape of the side faces 136 is, for example, manufactured by machining the semiconductor substrate 131 using a laser, wherein the machining is carried out in particular in several steps with respectively decreasing beam waists of the laser.

In this case, an average angle 137 of an average side face cross section to a surface normal 138 of the upper side 134 is more than 0°, in particular at least 5°, in particular at least 15°.

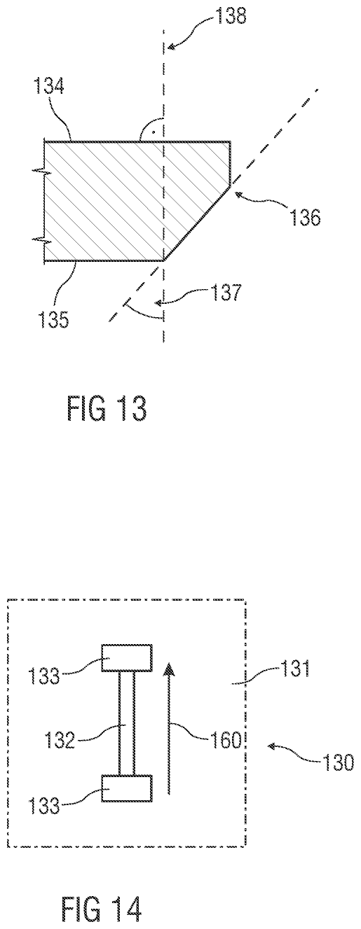

FIG. 13 shows a sectional illustration of a further possible exemplary embodiment of a semiconductor substrate 131 of a measuring element 130 in an edge region.

In contrast to the exemplary embodiment shown in FIG. 10, the side faces 136 of the semiconductor substrate 131 are tapered continuously only in sections from the upper side 134 toward the lower side 135.

FIG. 14 depicts a plan view of a section of a possible embodiment of a measuring element 130 with a view of the upper side 134 of the semiconductor substrate 131 of the measuring element 130.

The measuring element 130 comprises a strip-shaped resistance track 132, which comprises contact surfaces 133 at its ends.

In this case, the resistance track 132 is formed by a structured p-type doping in the semiconductor substrate 131 and lies at least essentially in a {110} crystal plane of the silicon crystal, wherein its running direction 160, i.e., a measuring direction, extends at least essentially along a <110> crystal direction or a <111> crystal direction. Alternatively, the at least one resistance track 132 is formed by a structured n-type doping in the semiconductor substrate 131 and lies at least essentially in a {100} crystal plane or a {110} crystal plane of the silicon crystal, wherein the running direction 160 thereof, i.e., a measuring direction, extends at least essentially along a <100> crystal direction.

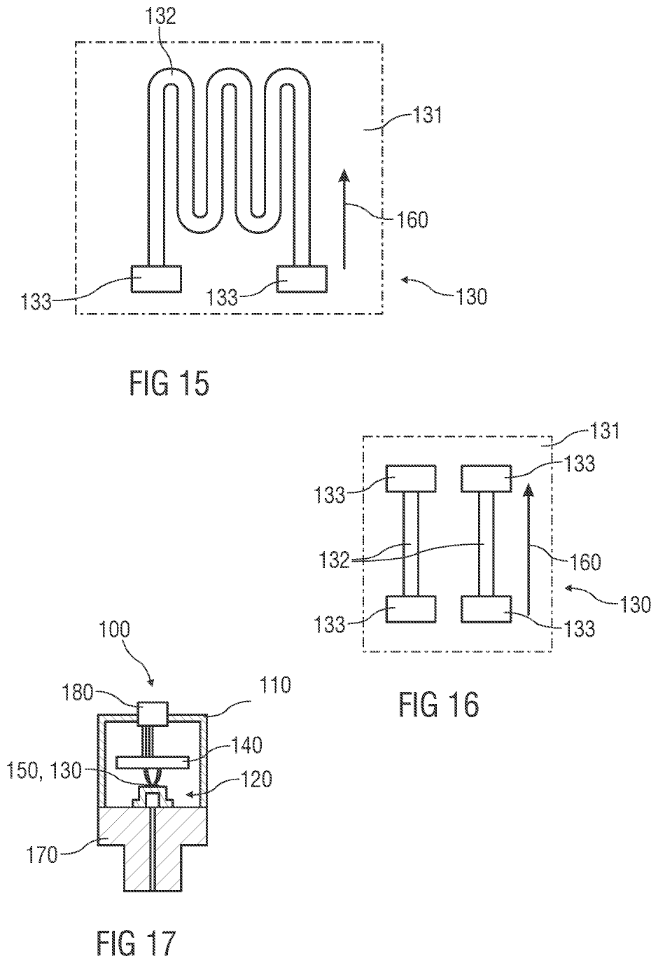

FIG. 15 shows a plan view of a detail of a possible further embodiment of a measuring element 130, with a view of the upper surface 134 of the semiconductor substrate 131 of the measuring element 130.

In contrast to the exemplary embodiment shown in FIG. 14, the resistance track 132 has a meandering shape. The resistance track in a meandering shape enables that a long strain of the resistance track 132 in the direction of the strain load is achieved even on a semiconductor substrate 131 with limited dimensions, while at the same time the strain of the resistance track 132 in the transverse direction being small. As a result, the achievable measurement signal can be enhanced, and the measurement accuracy can consequently be improved.

FIG. 16 shows a plan view of a section of a possible further exemplary embodiment of a measuring element 130 with a view of the upper side 134 of the semiconductor substrate 131 of the measuring element 130.

In contrast to the exemplary embodiment shown in FIG. 14, the measuring element 130 comprises two resistance tracks 132, wherein the resistance tracks 132 in particular are arranged parallel to one another, and contact surfaces 133 of the resistance tracks 132 are electrically insulated from one another.

FIG. 17 shows a sectional illustration of a section of a possible exemplary embodiment of a pressure sensor 100.

The pressure sensor 100 is configured to convert a pressure into an electrical signal, and includes a sensor body 120, a terminal body 170, a housing 110, an evaluation electronics 140 and a transmission 180.

Here, the terminal body 170 is sealingly connected to the sensor body 120 and sealingly connectable to a fluid source. By means of the terminal body 170, a fluid can be introduced in the sensor body 120.

The evaluation electronics 140 is electrically connected to the at least one resistance track 132 and adapted to convert a change in resistance of the resistive track 132 to an electrical measurement signal.

The housing 110 is connected to the terminal body 170, so that the membrane 121, the measuring element 130 and the evaluation electronics 140 are at least in sections, that is, at least partially, enclosed by the housing 110.

The transmission 180 is connected to the evaluation electronics 140 in such a way that it converts the electrical measurement signal to an electrical output signal and either makes it available by means of contacts that are accessible from outside the housing 110 or emits it as a radio signal.

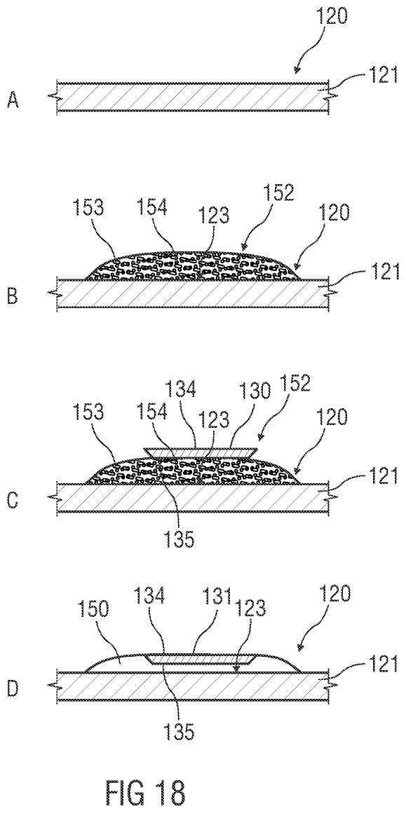

FIG. 18 shows sectional views of a section of a sensor body 120 during various steps A through E of a possible embodiment of a method for manufacturing the same.

In the method, in a step a sensor body 120, at least one measuring element 130 and a lead-free glass solder paste 152 are provided. The glass solder paste 152 comprises glass particles 153 and volatile, in particular organic, components 154.

In a step B, the glass solder paste 152 is applied to a surface portion 123 of the membrane 121 of the sensor body 120.

In a step C, the measuring element 130 is applied to the glass solder paste 152 in such a way that its lower side 135 is placed on the glass solder paste 152 or is pressed slightly into it.

Subsequently, in a step D, the sensor body 120 is heated to at least a temperature and the sensor body 120 is stored at this temperature for a storage period so that the volatile components 154 of the glass solder paste 152 are vaporized, the glass particles 153 melt, and the measuring element 130 sinks into a glass solder 150 thus created. For example, the temperature to which the sensor body 120 is heated is between 300 degrees Celsius and 600 degrees Celsius. The sensor body 120 is stored at this temperature, for example, for a storage period between 30 seconds and 5 hours. Suitable temperatures and storage times depend on the selected glass solder make and its specifications. In particular, the heating and storage of the sensor body 120 can take place over at least two stages, wherein at a first lower temperature stage initially the volatile components 154 of the glass solder paste 152 are vaporized and then, at a second higher temperature stage, the glass particles 153 are re-melted to a glass solder 150.

In a step E, not shown, this is followed by a cooling of the sensor body 120 so that the glass solder 150 solidifies.

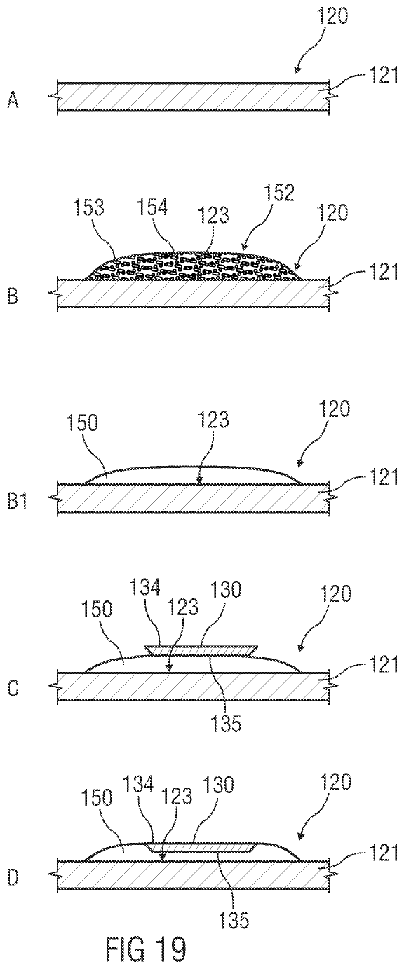

FIG. 19 shows sectional views of a section of a sensor body 120 during various steps A through D of a further possible embodiment of a method for its manufacture.

In contrast to the process shown in FIG. 18, a step B1 is carried out between step B and step C, in which the sensor body 120 is heated to a temperature and the sensor body 120 is stored at this temperature for a storage period, so that the volatile components 154 of the glass solder paste 152 already vaporize and the glass particles 153 melt before the measuring element 130 is applied on the glass solder paste 152. For example, the temperature to which the sensor body 120 is heated is between 300 degrees Celsius and 600 degrees Celsius. The sensor body 120 is stored at this temperature, for example, for a storage period between 30 seconds and 5 hours. Suitable temperatures and storage periods depend on the selected glass solder make and its specifications. In particular, the heating and storage of the sensor body 120 can take place over at least two stages, wherein initially the volatile components 154 of the glass solder paste 152 are vaporized at a first lower temperature stage and then, at a second higher temperature stage, the glass particles 153 are re-melted to a glass solder 150.

The measuring element 130 is applied to the heated glass solder paste 152 in step C, so that the former sinks in step D. As a result, the measuring element 130 is only exposed to a small amount of heat.

As a result, in a step E, not shown, the sensor body 120 is cooled so that the glass solder 150 solidifies.

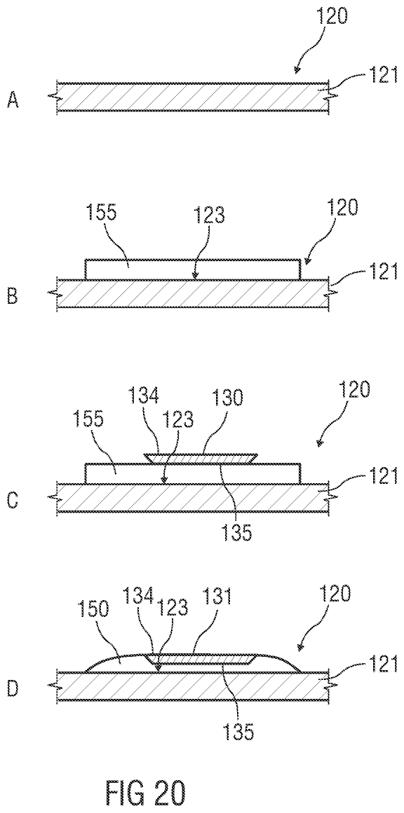

FIG. 20 shows sectional views of a section of a sensor body 120 during various steps A through E of a further possible embodiment of a method for the manufacture thereof.

In contrast to the exemplary embodiment of the method shown in FIG. 18, a molded glass part 155 is used instead of the glass solder paste 152.

Here, in a step A, a sensor body 120, at least one measuring element 130 and at least one lead-free molded glass part 155 are provided, before in a step B the molded glass part 155 is placed on a surface portion 123 of the membrane 121 of the sensor body 120.

In a step C, the measuring element 130 is applied on the molded glass part 155, before in a step D the sensor body 120 is heated to a temperature and the sensor body 120 is stored at this temperature for a storage period, so that the molded glass part 155 melts and the measuring element 130 sinks into a glass solder 150 thus created. For example, the temperature to which the sensor body 120 is heated is between 300 degrees Celsius and 600 degrees Celsius. The sensor body 120 is stored at this temperature, for example, for a storage period between 30 seconds and 5 hours. Suitable temperatures and storage times depend on the selected molded glass part make and its specifications.

Then, in a step E, not shown, the sensor body 120 is cooled so that the glass solder 150 solidifies.

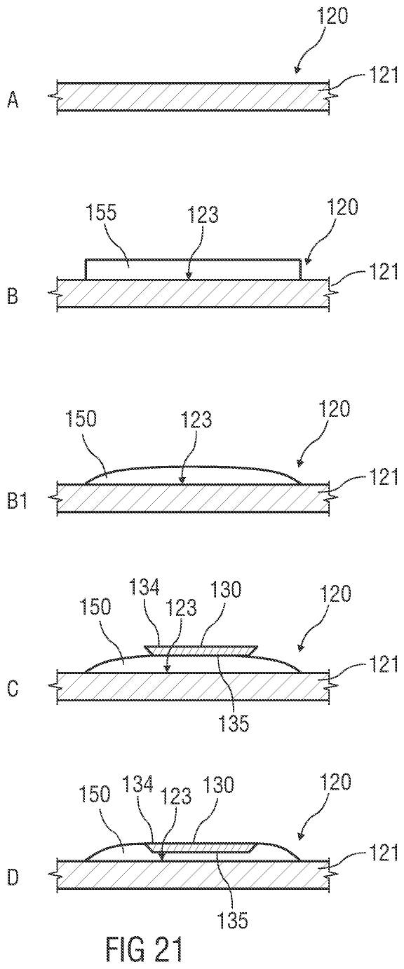

FIG. 21 shows sectional views of a section of a sensor body 120 during various steps A through D of a further possible embodiment of a method for its manufacture.

In contrast to the process illustrated in FIG. 20, a step B1 is performed between step B and step C in which the sensor body 120 is heated to a temperature and the sensor body 120 is stored at this temperature for a storage period, so that the molded glass part 155 melts to a glass solder 150 and adheres to the membrane 121, before the measuring element 130 is applied on the glass solder 150. For example, the temperature to which the sensor body 120 is heated is between 300 degrees Celsius and 600 degrees Celsius. The sensor body 120 is stored at this temperature, for example, for a storage period between 30 seconds and 5 hours. Suitable temperatures and storage times depend on the selected molded glass part make and its specifications.

The measuring element 130 is applied to the heated glass solder paste 152 in step C, so that it sinks in a step D. As a result, the measuring element 130 is only exposed to a small amount of heat.

In a not-shown step E, the sensor body 120 is cooled so that the glass solder 150 solidifies.

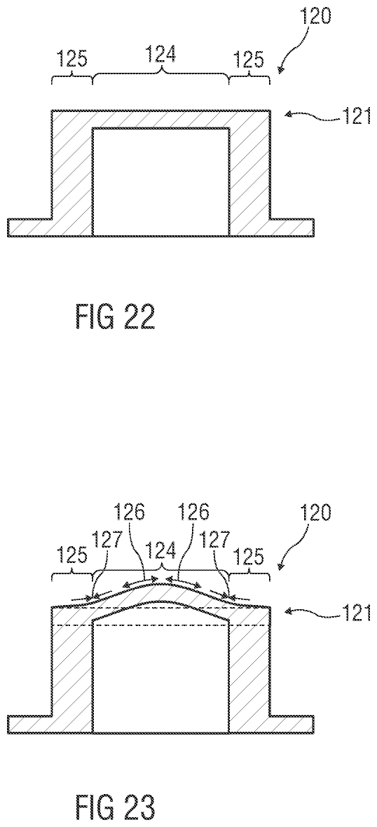

FIG. 22 shows a sectional view of a possible embodiment of a sensor body 120 in an unloaded state. FIG. 23 shows the sensor body 120 in a loaded, i.e., in a pressurized state, or in a state in which forces are introduced in the sensor body.

It can be seen here that in a loaded state, the membrane 121 bulges in a central region 124 in such a way that on its side facing the measuring element 130, surface portions with strong positive strain (stretching) 126 of the surface are formed and surface portions with strong negative strain (compression) 127 of the surface are formed. The outer region 125 of the membrane 121 adjoining the central region 124 experiences essentially no deformation. The position of surface portions 123 with a strong strain 126 or with strong compression 127 of the surface depends on the particular shape of the membrane 121.

To achieve a particularly reliable and accurate measurement of the shape change of the membrane 121, it is provided in one possible embodiment of the sensor body 120 that in the central region 124, two resistance tracks 132 are disposed in such a manner in a surface portion with a strong positive strain (stretching) 126 of the surface that the running direction 160 extends in the direction of the possible stretch. The resistance tracks 132 can be divided between two measuring elements 130 or arranged on a common measuring element 130. Two further resistance tracks 132 are arranged in a surface portion with strong negative strain (compression) 127 in such a way that their running direction 160 extends in the direction of the possible compression 127. These resistance tracks 132 can also be divided between two measuring elements 130 or arranged on a common measuring element 130. The four resistance tracks 132 are connected to a Wheatstone measuring bridge 139 in such a way that the two resistance tracks, which are disposed in a region with the same strain direction, in each case lie diagonally opposite in the circuit diagram of the measuring bridge.

Here, a large voltage signal is generated in a particularly advantageous manner, which results from the fact that when deformed, the electrical resistance of the resistance tracks 132 increases in areas with strong stretching 126 and the electrical resistance of the resistance tracks 132 decreases in areas with strong compression 127.

In a further possible embodiment of the sensor body 120, it is provided that a total of four resistance tracks 132 are disposed on the membrane 121 and are connected to a Wheatstone measuring bridge 139, wherein at least one resistance track 132 is arranged in the central region 124 of the membrane 121 in a surface portion with strong stretching 126 or severe compression 127, while the remaining resistance tracks 132 are arranged in the edge region 125.

Here, a very precise voltage signal is generated in a particularly advantageous manner, which results from the fact that the at least one resistance track 132 disposed in the central region 124 is deformed upon pressurization of the sensor body 120 and changes its resistance, while the other resistance tracks 132 are not substantially deformed and thus show no change in resistance.

The voltage signal can be amplified by the fact that the resistance tracks 132 are each formed by the structured p-type doping in the semiconductor substrate 131 and at least essentially lie in the {110} crystal plane of the silicon crystal, wherein their direction of extension 160 runs at least essentially along a <110> crystal direction or the <111> crystal direction, or alternatively, the resistance tracks 132 are each formed by the structured n-type doping in the semiconductor substrate 131 and at least essentially lie in the {100} crystal plane or the {110} crystal plane of the silicon crystal, wherein their direction of extension 160 runs at least substantially along the <100> crystal direction.

In a further possible configuration of the sensor body 120, four resistance tracks 132 are formed in the semiconductor substrate 131 of a single measuring element 130, wherein the resistance tracks 132 are formed by a structured p-type doping in the semiconductor substrate 131 and at least essentially lie in a {110} crystal plane of the silicon crystal. Two of the four resistance tracks 132 form a first pair, which is oriented at least substantially along a <110> crystal direction or a <111> crystal direction or extends in one of these crystal directions. The remaining two resistance tracks 132 form a second pair, which is aligned substantially perpendicular to the alignment of the first pair of resistance tracks. Thus, the first pair of resistance tracks 132 runs in a direction in which the resistance, as already described in a previous section, depends essentially only on strain in the direction of extension of the tracks, while the second pair of resistance tracks 132 runs in a transverse direction thereto, in which the resistance is essentially independent of the strain in this transverse direction. The four resistance tracks 132 can in particular be interconnected to form a Wheatstone bridge circuit in such a way that the resistance tracks 132 of the first pair and the resistance tracks 132 of the second pair are each diagonally opposite in the circuit diagram of the bridge circuit. This has the advantage that a measuring element 130 with such a measuring bridge is essentially only sensitive to strain, that is to say stretching/compression, along the orientation of the first pair of resistance tracks 132, and a very precise measuring signal can be tapped in relation thereto. The connection to a measuring bridge can be formed within the semiconductor substrate 131 or can be manufactured outside the measuring element 130 by contacting the individual resistance tracks 132. A sensor body 120 can be manufactured particularly simply and inexpensively with such a measuring element 130, since only one measuring element 130 has to be applied. In addition, this can be arranged anywhere on the membrane. The sensor body 120 can be manufactured particularly advantageously by arranging such a measuring element 130 centrally in a central region 124 on the membrane 121, since essentially no asymmetries are created in the loading of the membrane 121.

FIG. 24 shows a possible embodiment of a force measuring device 190 for converting a force F to an electric signal.

The force measuring device 190 comprises two sensor bodies 120, two storage areas 191, a load introduction area 192, an evaluation electronics 140, a transmission 180 and two deformation sections 193, in which in each case one sensor body 120 is disposed.

In this case, the deformation sections 193 are connected with the respective sensor body 120, and the force F can be introduced in the sensor body 120 by means of said deformation sections 193.

The evaluation electronics 140 is in each case electrically connected to the at least one resistance track 132, not shown in detail, of the respective sensor body 120 and adapted to convert a change in resistance of the resistance tracks 132 to an electrical measurement signal.

The transmission 180 is connected such with the evaluation electronics 140 that it converts the electrical measurement signal to an electrical output signal and either makes it available by means of contacts or emits it as a radio signal.

FIG. 25 shows a further possible exemplary embodiment of a force measuring device 190 for converting a force F to an electrical signal.

In contrast to the embodiment illustrated in FIG. 24, the force measuring device 190 comprises a storage area 191, a load introduction area 192, an evaluation electronics 140, a transmission 180 and a deformation section 193, in which two sensor bodies 120 are arranged.

The deformation section 193 is connected to the sensor bodies 120 and the force F can be introduced in the sensor bodies 120 by means of the deformation section 193.

Between the sensor bodies 120, a slot-shaped recess 194 is formed in the deformation section 193, so that with an introduction of the force F, a resulting deformation of the deformation section 193 is focused in the area of the sensor bodies 120 and thus, the deformation is very reliable detected. The recess 194 can also have any other desired shape.

The invention is not restricted to the preceding, detailed exemplary embodiments. It can be modified within the scope of the following claims.

Individual aspects from the dependent claims can also be combined with one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a sensor body, the method comprising:
A. providing a sensor body, at least one measuring element and either a lead-free glass solder paste or at least one lead-free molded glass part, wherein the lead-free glass solder paste comprises glass particles and volatile, organic components;
B. applying the lead-free glass solder paste on at least one surface portion of a membrane of the sensor body or placing the lead-free molded glass part on the at least one surface portion of the membrane of the sensor body;
C. applying the at least one measuring element to the lead-free glass solder paste or to the lead-free molded glass part;
D. heating the sensor body to a temperature and storing the sensor body at the temperature for a storage period, so that either the volatile, organic components of the lead-free glass solder paste vaporize and the glass particles melt to form a lead-free glass solder into which the at least one measuring element sinks without an application of force or the lead-free molded glass part melts to create a lead-free glass solder into which the at least one measuring element sinks without an application of force; and
E. after step D, cooling the sensor body so that the lead-free glass solder solidifies thereby connecting the at least one measuring element to the membrane of the sensor body.

2. The method according to claim 1, wherein the at least one measuring element has a semiconductor substrate, the semiconductor substrate having an upper side and a lower side, wherein, in a plan view, a surface of the upper side fully projects beyond a surface of the lower side over an entire edge of the surface of the lower side such that the lower side has a smaller area than the upper side, wherein side faces of the semiconductor substrate continuously taper from the upper side in a direction of the lower side, at least in sections, such that the semiconductor substrate has a tapered configuration,
wherein in step C, the lower side of the semiconductor substrate of the at least one measuring element is applied to the lead-free glass solder paste or to the lead-free molded glass part, and
wherein in step D, the at least one measuring element sinks into the lead-free glass solder, starting from the lower side of the semiconductor substrate, without application of force due to the tapered configuration of the semiconductor substrate.

3. The method according to claim 1, wherein the temperature is between 300° C. and 600° C.

4. A method for manufacturing a sensor body, the method comprising:
A. providing a sensor body, at least one measuring element and either a lead-free glass solder paste or at least one lead-free glass part, wherein the lead-free glass solder paste comprises glass particles and volatile, organic components;
B. applying the lead-free glass solder paste on at least one surface portion of a membrane of the sensor body or placing the lead-free molded glass part on the at least one surface portion of the membrane of the sensor body;
C. heating the sensor body to a temperature and storing the sensor body at the temperature for a storage period, so that the volatile components of the lead-free glass solder paste vaporize and the glass particles melt to form a lead-free glass solder or the lead-free molded glass part melts to create a lead-free glass solder and adheres to the membrane;
D. applying the at least one measuring element to the lead-free glass solder so that the measuring element sinks into the lead-free glass solder without application of force; and
E. after step D, cooling the sensor body so that the lead-free glass solder solidifies thereby connecting the at least one measuring element to the membrane of the sensor body.

5. The method according to claim 4, wherein the at least one measuring element has a semiconductor substrate, the semiconductor substrate having an upper side and a lower side, wherein, in a plan view, a surface of the upper side fully projects beyond a surface of the lower side over an entire edge of the surface of the lower side such that the lower side has a smaller area than the upper side, wherein side faces of the semiconductor substrate continuously taper from the upper side in a direction of the lower side, at least in sections, such that the semiconductor substrate has a tapered configuration,
wherein in step D, the lower side of the semiconductor substrate of the at least one measuring element is applied to the lead-free glass solder so that the at least one measuring element sinks into the lead-free glass solder, starting from the lower side of the semiconductor substrate, without application of force due to the tapered configuration of the semiconductor substrate.

6. The method according to claim 5, wherein the temperature is between 300° C. and 600° C.

7. A method for manufacturing a sensor body, the method comprising:
A. providing a sensor body, at least one measuring element and either a lead-free glass solder paste or at least one lead-free glass part, wherein the lead-free glass solder paste comprises glass particles and volatile, organic components;
B. applying the lead-free glass solder paste on at least one surface portion of a membrane of the sensor body or placing the lead-free molded glass part on the at least one surface portion of the membrane of the sensor body;
C. heating the sensor body to a temperature and storing the sensor body at the temperature for a storage period, so that the volatile components of the lead-free glass solder paste vaporize and the glass particles melt to form a lead-free glass solder or the lead-free molded glass part melts to create a lead-free glass solder and adheres to the membrane;
D. after step C, cooling the sensor body so that the lead-free glass solder solidifies;
E. after step D, applying the at least one measuring element to the lead-free glass solder;
F. after step E, re-heating the sensor body to reliquify the lead-free glass solder so that the measuring element sinks into the lead-free glass solder without application of force; and
G. after step F, cooling the sensor body so that the lead-free glass solder re-solidifies thereby connecting the at least one measuring element to the membrane of the sensor body.

8. The method according to claim 7, wherein the at least one measuring element has a semiconductor substrate, the semiconductor substrate having an upper side and a lower side, wherein, in a plan view, a surface of the upper side fully projects beyond a surface of the lower side over an entire edge of the surface of the lower side such that the lower side has a smaller area than the upper side, wherein side faces of the semiconductor substrate continuously taper from the upper side in a direction of the lower side, at least in sections, such that the semiconductor substrate has a tapered configuration,
wherein in step E, the lower side of the semiconductor substrate of the at least one measuring element is applied to the lead-free glass solder so that the at least one measuring element sinks into the lead-free glass solder, starting from the lower side of the semiconductor substrate, without application of force due to the tapered configuration of the semiconductor substrate.

9. The method according to claim 8, wherein the temperature is between 300° C. and 600° C.
